(19) United States
(12) Patent Application Publication
(10) Pub. No.: US 2022/0228421 A1
(43) Pub. Date: Jul. 21, 2022

(54) ADJUSTABLE JAMB EXTENSION

(71) Applicant: Vinyl Window Designs, Toronto (CA)

(72) Inventors: Pasqualino D'UVA, Toronto (CA); Phil SPATAFORA, Toronto (CA)

(21) Appl. No.: 17/153,136

(22) Filed: Jan. 20, 2021

(51) Int. Cl. E06B 1/34

(52) U.S. Cl. CPC E06B 1/342

(57) ABSTRACT

Disclosed is a window or door frame assembly having a jamb extension coupling a window or door frame. The window or door frame has a longitudinal member having a surface defining a channel formed along the length of the longitudinal member. A jamb extension having a first face and a second face, a plurality of spaced apart grooves formed on the first face and extending along the length of the jamb extension, with the jamb extension configured to matingly engage the channel. A tooth coupled to the longitudinal member and configured to engage one of the plurality of grooves for coupling the jamb extension to the window or door frame. Also disclosed are kits and process for the window or door frame assembly.

### FIELD

The specification relates to an adjustable jamb extension. In particular, the specification relates to a window or door frame assembly having a variable depth, and which is adaptable for use with a thin or thick wall construction.

### BACKGROUND

Factory prebuilt window or door units are desirable as they allow for ease for installation. However, due to the different size thickness of walls at the point of installation, prefabrication of window or door units that can be adapted for use with walls of various thickness can be challenging.

Although the specification makes specific reference to a window or window frame, due to the similarities between a window frame assembly and a door frame assembly, it should be understood that the specification and claimed invention is applicable to both a window frame assembly and a door frame assembly. This has been done for the purposes of understanding and simplicity. As such, references in the description, such as, to a window frame should be considered as inclusive of both a window frame assembly and a door frame assembly. Similarly, reference to a window frame should be considered as inclusive of both a window frame and a door frame.

A typical window (or door) 2 has a window (or door) frame 4, having a head 6 at the top of the window (or door) frame 4, a sill 8 positioned at the bottom of the window (or door) frame 4, a pair of opposed and spaced-apart vertical window (or door) jambs 10 connecting the window (or door) sill 8 to the head 6 of the window (or door) frame 4. Glass 12, or other parts, such as a sash (not shown) in a double hung or sliding window (not shown) or door (not shown), can be coupled, affixed to or positioned between the head 6, sill 8 and jambs 10 of the window or door frame 4.

During installation, a window (or door) frame 4 is positioned in a window (or door) opening (not shown) of a wall construction 14. With reference to FIG. 3, depending upon the depth of the window frame 4 compared to the depth of the wall construction 14, the interior wall 16 of the wall construction 14 can be spaced (B) from an interior surface of the window (or door) frame 18, leaving exposed the interior portion of the wall construction 14. A jamb extension 20 can be used to cover the exposed surface.

Jamb extensions 20 are an interior window (or door) feature which allows one to fit the window (or door) frame 4 to window openings of varying depths. By extending the window (or door) jambs 10 to the precise length required, a window (or door) frame 4 is able to sit flush with the interior wall. So, if one has a window (or door) frame 4 that isn't quite as deep as the wall opening, jamb extensions 20 can be used to make it fit.

For installation, a jamb extension 20 is coupled to the interior surface of the window (or door) frame 18, where the proximal end of the jamb extension 22 is coupled to the window (or door) frame 4 and the jamb extension 20 extends to the interior wall 16 of the wall construction 14. In one embodiment, for example and without limitation, as shown in FIG. 3, the distal end of the jamb extension 24 lies flush with the surface of the interior wall 16 of the wall construction 14.

In one embodiment, as shown in FIG. 3, the jamb extension 20 is coupled to the window (or door) frame 4 using a clip 26, or other coupling mechanism known in the art. Further, due to the differences in depth of wall constructions 14 at different sites, a jamb extension 20 having a standardized depth cannot be utilized. Rather, in many instances, the jamb extension 20 is cut to size and installed in the factory, and at times on-site; leading to increased cost, loss of material and delay in construction.

There is a need in the art for an improved window or door frame assembly having a window or door frame and a jamb extension. In addition, there is a need in the art for a window or door frame assembly having a window or door frame and a jamb extension that can help address some of the challenges in the art, including those mentioned herein. Moreover, there is a need in the art for a kit containing a window or door frame and a jamb extension for assembling the window or door frame assembly. Furthermore, there is a need in the art for a process for manufacturing a kit for assembling a window or door frame assembly containing a window or door frame and a jamb extension. In addition to the above, there is a need in the art for a process for manufacturing a window or door frame assembly containing a window or door frame and a jamb extension.

### SUMMARY

In one aspect, the specification relates to a window or door frame assembly comprising a jamb extension coupling a window or door frame;

the window or door frame comprising a longitudinal member having a surface defining a channel formed along the length of the longitudinal member;

a jamb extension having a first face and a second face, a plurality of spaced apart grooves formed on the first face and extending along the length of the jamb extension, the jamb extension configured to matingly engage the channel; and

a tooth coupled to the longitudinal member and configured to engage one of the plurality of grooves for coupling the jamb extension to the window or door frame.

In another aspect, the specification relates to a kit containing the window or door frame and a jamb extension for assembling the window or door frame assembly, as disclosed herein.

In a further aspect, the specification relates to a process for manufacturing the kit for assembling a window or door frame assembly containing a window or door frame and a jamb extension, as disclosed herein.

In still another aspect, the specification relates to a process for manufacturing a window or door frame assembly containing a window or door frame and a jamb extension, as disclosed herein.

### BRIEF DESCRIPTION OF THE DRAWINGS

Reference will now be made, by way of example, to the accompanying drawings which show example embodiments of the present application, and in which:

FIG. 1 is a front view of an embodiment of a window frame assembly in accordance with the specification;

FIG. 2 is a perspective view of an embodiment of a window frame assembly in accordance with the specification;

FIG. 3A is a cross sectional view along the lines A-A showing the window frame without the jamb extension and prior to positioning in a window opening, and FIG. 3B is a cross sectional view along the lines A-A showing the window frame with the jamb extension and after positioning in a window opening;

FIG. 4A is a cross sectional view along the lines A-A showing an embodiment of the window frame, and FIG. 4B is an embodiment of a jamb extension prior to engagement with the window frame, in accordance with the specification; and

FIGS. 5A and 5B are cross sectional views along the lines A-A showing the different levels of engagement of an embodiment of a jamb extension in the window frame, in accordance with the specification.

Similar reference numerals may have been used in different figures to denote similar components.

### DESCRIPTION OF EXAMPLE EMBODIMENTS

An embodiment of the claimed invention is described with reference to the accompanied drawings.

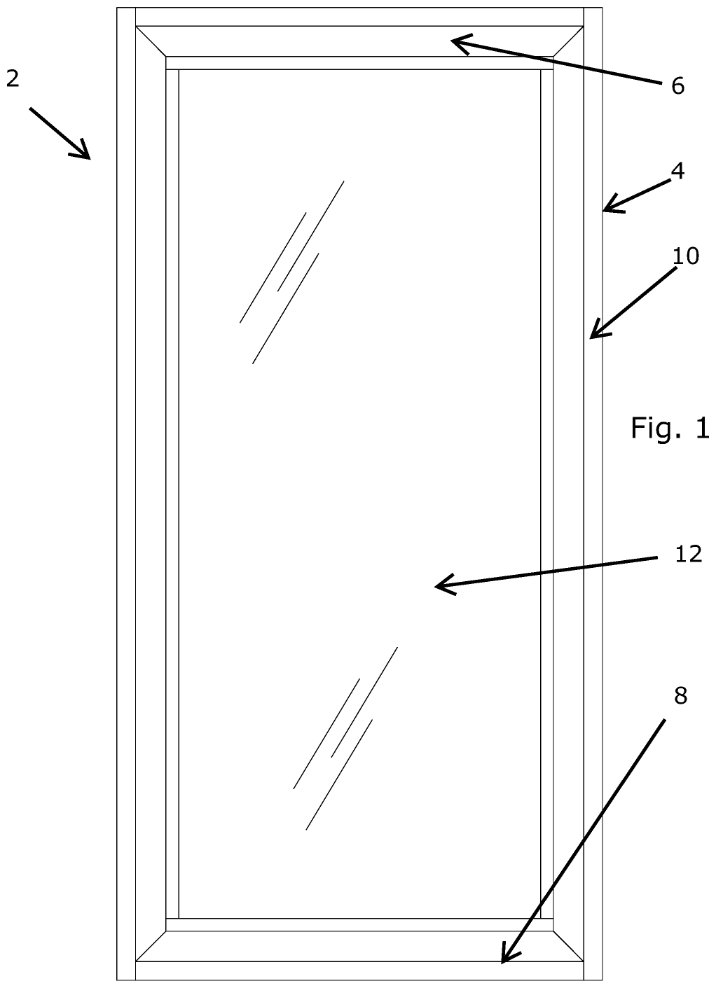

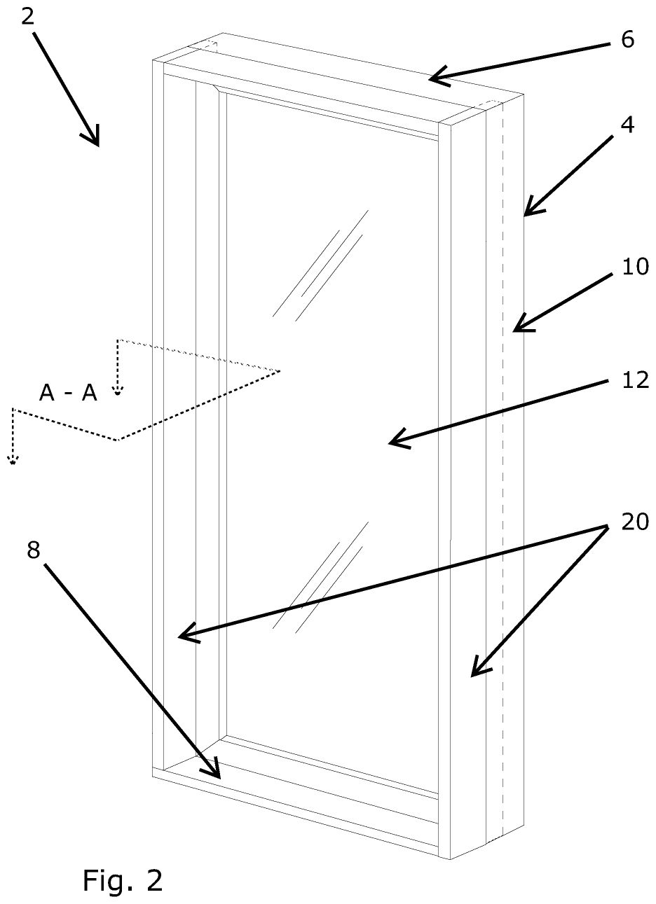

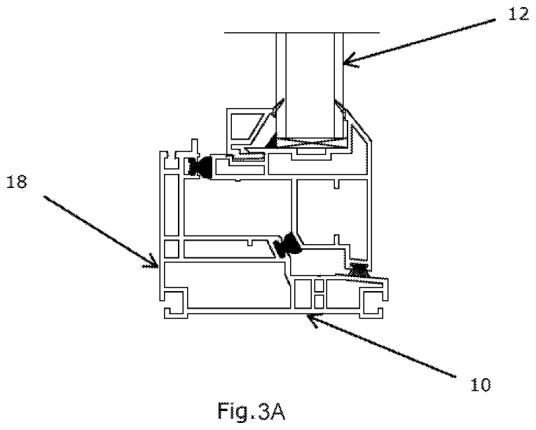

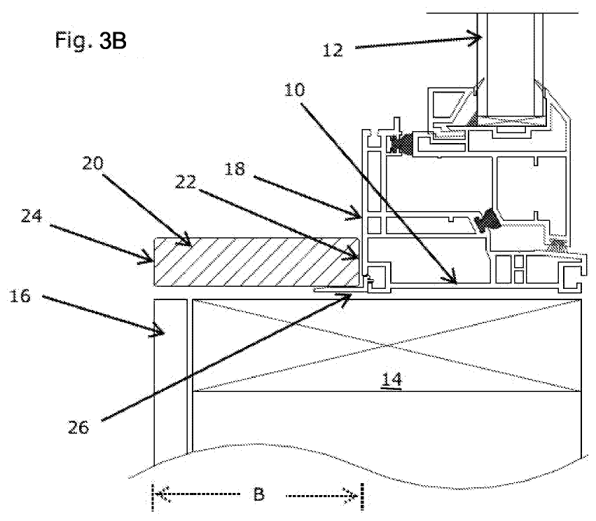

FIGS. 1 and 2 show a front and perspective views, respectively, of a window 2 having a window frame 4. Typically, the window frame 4 has a head 6 at the top portion of the window frame 4, a sill 8 positioned at the bottom of the window frame 4, a pair of opposed and spaced-apart vertical window jambs 10 connecting the window still 8 to the head 6 of the window frame 4. Glass 12, or other parts, such as a sash (not shown) in a double hung or sliding window (not shown) or door (in a door frame; not shown), can be coupled, affixed to or positioned between the head 6, sill 8 and jambs 10 of the window (or door) frame 4.

As mentioned above, during installation, a window frame 4 is positioned in a window opening (not shown) of a wall construction 14. When the depth of the window frame 4 is different from the depth of the wall construction 14, a jamb extension 20 can be used to fit the window frame 4 in the window opening of varying depths.

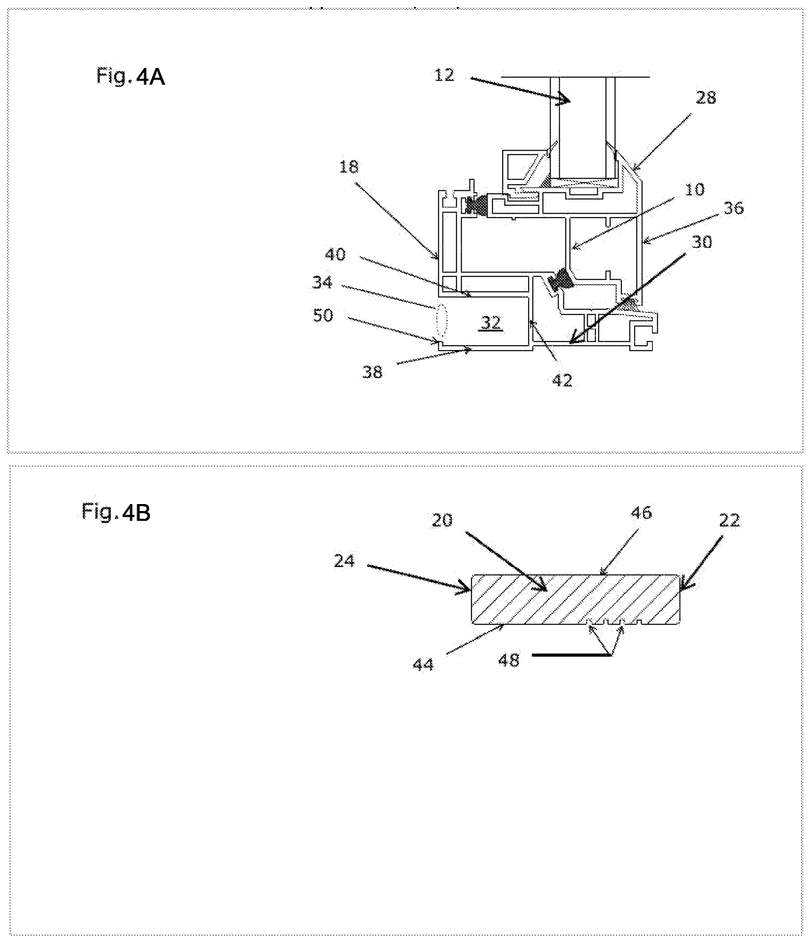

FIG. 4A shows a cross sectional view along the lines A-A showing an embodiment of the window frame 4, in accordance with the specification. The window frame 4 has longitudinal members, such as the head 6, sill 8 or jamb 10. The embodiment shown in FIG. 4A, shows a cross-sectional view of an embodiment of a jamb 10, which at a first end 28 is coupled to the glass 12, while a second end 30 of the jamb 10 can be attached to the wall construction 14. The jamb 10 has a surface 18 (also noted as—interior surface of window frame), which can be provided with features for coupling the jamb 10 to the jamb extension 20.

In the embodiment shown in FIG. 4A, the surface 18 of the jamb 10 (or any other longitudinal member) has a channel 32. The channel 32 is formed on the surface 18 along the length of the jamb 10 (or any other longitudinal member). In one embodiment, for example and without limitation, the channel 32 is formed in a single plane along the length of the jamb 10.

The surface 18 defining the channel 32 has an opening 34 (shown as a dotted circle) formed along the length of the jamb 10, and allows for insertion of the jamb extension 20 into the channel 32. As such, the channel opening 34 is sized to accommodate the jamb extension 20, with the depth of the channel 32, measured from the internal surface 18 towards the opposing external surface 36. In one embodiment, for example and without limitation, the channel 32 is formed as an internal channel with the jamb 10, as disclosed herein. However, the surface 18 can be provided with features, such that the channel 32 can be formed outside the main portion of the jamb (for instance, an external channel).

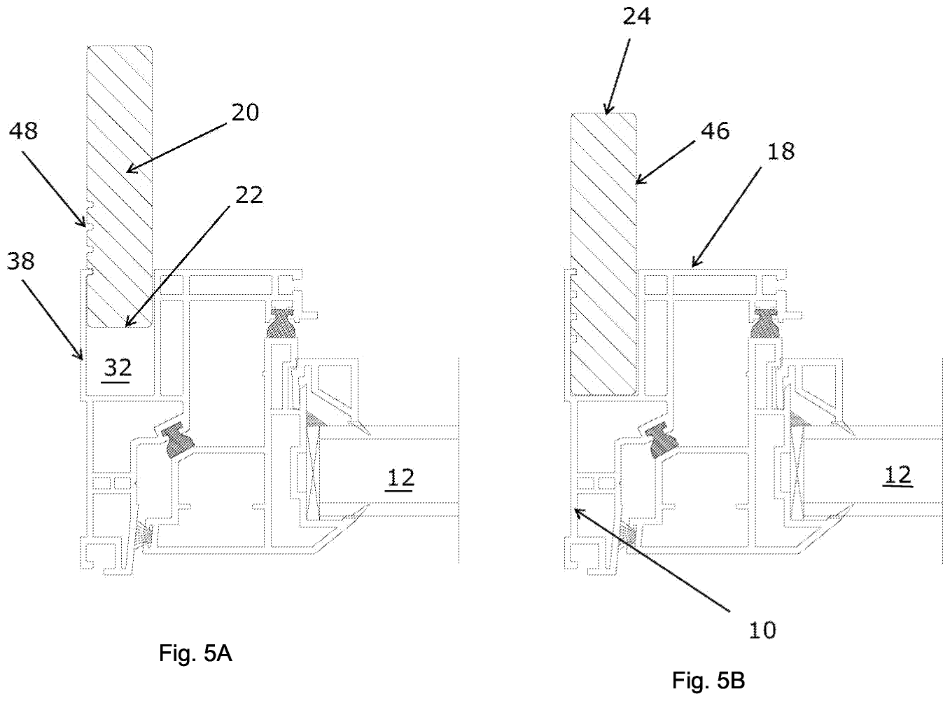

In one embodiment, as disclosed herein, the surface 18 has a channel floor 38, channel ceiling 40 and a stop 42, establishing the size of the channel 32. The channel stop 42 prevents further insertion of the jamb extension 20 in the jamb 10. The channel floor 38 provides the surface on which the jamb extension 20 can sit upon insertion. In one embodiment, for example and without limitation, the channel floor 38 lies in a different plane than the surface at the second end 30 of the jamb 10, with the channel floor 38 being more distal to the first end 28 of the jamb 10 than the second end 30. This can help to ensure proper alignment of the jamb extension 20, such that a first face 44 of the jamb extension 20 can lie in the same plane as the surface at the second end 30 of the jamb 10. In another embodiment, for example and without limitation, the first face 44 of the jamb extension 20 contacts the channel floor 38, while a second face 46 of the jamb extension 20 can contact the channel ceiling 40 (FIGS. 5A & 5B).

As noted above, the jamb extension 20, as disclosed herein (FIG. 4B) can have a second face 46, which is opposed to the first face 44 of the jamb extension 20. In one embodiment, for example and without limitation, the first face 44 of the jamb extension 20 has a plurality of spaced-apart grooves 48 along the length of the jamb extension 20. The number of grooves 48 is not particularly limited, and can be varied depending upon application and design requirements. As disclosed herein, the plurality of grooves 48 help establish the extent the jamb extension 20 is inserted into the channel 32 to help with alignment of the distal end 24 of the jamb extension 20 with the interior wall 16 of the wall construction 14.

The jamb 10 (or other longitudinal member of the frame) is provided with a tooth 50 configured to engage one of the plurality of grooves 48 to help affix the jamb extension 20 is position. In the embodiment disclosed in FIGS. 4A, 5A and 5B, the tooth 50 is coupled to and extends from the channel floor 38 towards the channel ceiling 40. In addition, the tooth 50 is coupled at the edge of the surface of the longitudinal member (such as, jamb), which can be the edge of the channel floor 38, as shown in drawings. The position of the tooth 50 is not particularly limited, so long it is positioned and configured to engage the plurality of grooves 48 to affix the jamb extension 20 in the channel 32. In one embodiment, for example and without limitation, the tooth 50 can be positioned on the channel floor 38 close to the edge that defines the channel opening 34, or in between the edge that defines the channel opening 34 and the channel stop 42, depending upon design and application requirements. In another embodiment, for example and without limitation, the tooth 50 can be coupled to the channel ceiling 40 and extends from the channel ceiling 40 towards the channel floor 38. In such an embodiment, the plurality of spaced-apart grooves 48 are formed along the length of the second face 46 of the jamb extension 20, such that the tooth 48 and grooves 48 can engage each other in a complementary manner to affix the jamb extension 20 in place.

The shape and size of the jamb extension 20 and channel 32 is not particularly limited, so long as the jamb extension 20 is can be inserted into the channel 32 to affix the jamb extension 20 at different levels of insertion in the jamb 10. Further, although the jamb extension 20 shown has a rectangular shape, with the channel 32 being complementary for receiving the jamb extension 20, other shapes are also possible depending upon design and application requirements.

FIGS. 5A and 5B show the coupling of the jamb extension 20 with the jamb 10, by insertion of the jamb extension 20 in the channel 32. Initially, the jamb extension 20 is inserted in the channel opening 34 of the channel 32. As shown in FIG. 5A, the tooth 50, provided on the channel floor 38, engages a first groove 48 on the first face 44 of the jamb extension 20. If the distal end 24 of the jamb extension 20 aligns with the interior wall 16 of the wall construction 14, the insertion of the jamb extension 20 can be stopped at this point. However, if the jamb extension 20 extends beyond the interior wall 16 of the wall construction 14 and into the interior of the room, the jamb extension 20 can be further inserted into the channel 32, where the tooth 50 engages a second groove of the plurality of grooves 48 (with the first groove being more proximate to the proximal end of the jamb extension 20 than the second groove). In the distal end 24 of the jamb extension 20 aligns with the interior wall 16 of the wall construction, no further insertion is required. In such a manner, the jamb extension 20 can be inserted into the channel 32 till it reaches the channel stop 42, and where the tooth 50 can engage a groove 48 (in the plurality of grooves 48) to couple the jamb extension 20 in channel 32, as shown in FIG. 5B.

The specification also relates to a kit comprising a window or door frame and a jamb extension for assembling the window or door frame assembly, as disclosed herein. In addition, the specification relates to a process for manufacturing the kit for assembling a window or door frame assembly containing a window or door frame and a jamb extension, as disclosed herein.

Also provided is a process for manufacturing a window or door frame assembly comprising a window or door frame and a jamb extension, as disclosed herein. The process involving forming the window or door frame, as disclosed herein. In addition, a jamb extension having a first face and a second face is formed, and is provided with a plurality of spaced apart grooves on the first face of the jamb extension and extending along the length of the jamb extension, where the jamb extension is configured to matingly engage the channel. The longitudinal member is provided with a tooth, with the tooth configured to engage one of the plurality of grooves for coupling the jamb extension to the window or door frame. The process for manufacturing is not particularly limited, and should be known to a person of skill in the art.

Parts List

A parts list is provided below to assist with better understanding of the exemplary embodiment disclosed herein, and is not intended to be limiting of the claimed invention.

| No. | Description |
|---|---|
| 2 | Window (or door) |
| 4 | Window or door frame |
| 6 | Head |
| 8 | Sill |
| 10 | Jamb |
| 12 | Glass (or door)s |
| 14 | Wall construction |
| 16 | Interior wall of wall construction |
| 18 | Interior surface of window/door frame |
| 20 | Jamb extension |
| 22 | Proximal end of jamb extension |
| 24 | Distal end of jamb extension |
| 26 | clip |
| 28 | First end of jamb |
| 30 | Second end of jamb |
| 32 | Channel |
| 34 | Channel opening |
| 36 | External surface of jamb |
| 38 | Channel floor |
| 40 | Channel ceiling |
| 42 | Stop |
| 44 | First face of the jamb extension |
| 46 | Second face of jamb extension |
| 48 | Grooves |
| 50 | Tooth |

Certain adaptations and modifications of the described embodiments can be made. Therefore, the above discussed embodiments are considered to be illustrative and not restrictive.

1. A window or door frame assembly comprising a jamb extension coupling a window or door frame;
the window or door frame comprising a longitudinal member having a surface defining a channel formed along the length of the longitudinal member;
the jamb extension, which is independent of the window or door frame, and having a first face and a second face, a plurality of spaced apart grooves formed on the first face and extending along the length of the jamb extension, the jamb extension configured to matingly engage the channel; and
a tooth coupled to the longitudinal member extending into the channel or at a channel opening, and configured to engage one of the plurality of grooves for coupling the jamb extension to the window or door frame.

2. The window or door frame assembly of claim 1, wherein the tooth is coupled to the surface defining the channel.

3. The window or door frame assembly of claim 1, wherein the tooth is coupled proximate to an edge of the surface defining the channel.

4. The window or door frame assembly of claim 1, wherein the tooth is coupled at an edge of the surface defining the channel.

5. The window or door frame assembly of claim 1, wherein the tooth is coupled to a channel floor of the channel.

6. The window or door frame assembly of claim 1, wherein the first face of the jamb extension faces away from a window or door.

7. The window or door frame assembly of claim 1, wherein the jamb extension has two, three or four spaced apart grooves.

8. A kit comprising a window or door frame and a jamb extension for assembling the window or door frame assembly; wherein
the window or door frame comprising a longitudinal member having a surface defining a channel formed along the length of the longitudinal member;
the jamb extension, which is independent of the window or door frame, and having a first face and a second face, a plurality of spaced apart grooves formed on the first face and extending along the length of the jamb extension, the jamb extension configured to matingly engage the channel; and
a tooth coupled to the longitudinal member extending into the channel or at a channel opening, and configured to engage one of the plurality of grooves for coupling the jamb extension to the window or door frame.

9. The kit of claim 8, wherein the tooth is coupled to the surface defining the channel.

10. The kit of claim 8, wherein the tooth is coupled proximate to an edge of the surface defining the channel.

11. The kit of claim 8, wherein the tooth is coupled at an edge of the surface defining the channel.

12. The kit of claim 8, wherein the tooth is coupled to the surface defining the channel, the surface being proximate to the periphery of the window or door frame.

13. The kit of claim 8, wherein the first face of the jamb extension faces away from a window or door.

14. The kit of claim 8, wherein the jamb extension has two, three or four spaced apart grooves.

15. A process for manufacturing a window or door frame assembly comprising a window or door frame and a jamb extension, the process comprising:
forming the window or door frame comprising a longitudinal member having a surface defining a channel formed along the length of the longitudinal member;
forming the jamb extension, which is independent of the window or door frame, and having a first face and a second face,
forming a plurality of spaced apart grooves on the first face of the jamb extension and extending along the length of the jamb extension, wherein the jamb extension is configured to matingly engage the channel; and
providing a tooth which extends into the channel or at a channel opening, to the longitudinal member, the tooth configured to engage one of the plurality of grooves for coupling the jamb extension to the window or door frame.

16. The process of claim 15, wherein the tooth is coupled to the surface defining the channel.

17. The process of claim 15, wherein the tooth is coupled proximate to an edge of the surface defining the channel.

18. The process of claim 15, wherein the tooth is coupled at an edge of the surface defining the channel.

19. The process of claim 15, wherein the tooth is coupled to the surface defining the channel, the surface being proximate to the periphery of the window or door frame.

20. The process of claim 15, wherein the first face of the jamb extension faces away from a window or door.

21. The process of claim 15, wherein the jamb extension has two, three or four spaced apart grooves.
